(19) United States
(12) Patent Application Publication
(10) Pub. No.: US 2006/0004585 A1
(43) Pub. Date: Jan. 5, 2006

(54) Supplier advisory management system

(75) Inventors: Kaye E. Shukosky, Appleton, WI (US); Nathan A, Genke, Menasha, WI (US); Matthew T. Merten, Appleton, WI (US); Thomas J. Patrenets, Appleton, WI (US)

Correspondence Address: Dority & Manning, P.A., P.O. Box 1449, Greenville, SC, 29601, US

(73) Assignee: KIMBERLY-CLARK WORLDWIDE, INC.

(21) Appl. No.: 10/881,009

(22) Filed: Jun. 30, 2004

(51) Int. Cl. G06F 17/60

(52) U.S. Cl. 705/1

(57) ABSTRACT

A supplier advisory management system and associated method provide features and steps for a product manufacturer to enter advisories via a computer-based platform into an automated system. Advisories may include information identifying a given raw material provided from a supplier to a manufacturer as well as a defect reason associated with the material, and such information is stored in an advisory database. Notifications indicating a new advisory are then sent to the supplier as well as optionally selected individuals affiliated with the manufacturer. If corrective action is required on the part of the supplier because of the material defect, the supplier accesses a secure link to the advisory management system and submits a response which may be accepted or rejected by the manufacturer. Searching and report generation tools are provided to collect selected information stored in the advisory database and present such information in various formats for a user. Online communication messengers enable real-time communication between suppliers and manufacturers.

### FIELD OF THE INVENTION

The present invention generally concerns a system and method for managing the quality of raw materials received from suppliers by a product manufacturer. A real-time web-based system accessible by individuals on both the supplier and manufacturer level manages raw material defect complaints in the form of advisories.

### BACKGROUND

In the manufacturing of articles and goods by a product manufacturer, suppliers provide various goods and services that are combined by the product manufacturer to create an end product. Suppliers can provide such goods as raw materials or sub-components needed for manufacture of an end product. Suppliers can also provide goods related to packaging aspects of an end product or can provide services such as intermediate conditioning of a material or sub-component employed in the manufacture of an end product.

When raw materials, sub-components, packaging supplies, services, or other intermediate products are received by a product manufacturer, various steps are often taken to ensure that the quality of the supplied goods and/or services meet predetermined quality specifications. The complexity of such quality control may range from providing a standard certificate of conformance to completing a certificate of analysis (COA) that includes identification and specification data for a supplied product. An example of a system for managing COA data transfer between suppliers and manufacturers is disclosed in U.S. Patent Application 2003/0069795, which is incorporated by reference herein for all purposes. This exemplary system and others concern quality control of raw materials before or during the provision of such raw materials or other products from a supplier to a manufacturer.

In current systems, the process to ensure containment of a problem relating to the receipt of defective materials and subsequent permanent corrective actions on the part of the supplier is generally a manual advisory process. Known supplier advisory processes capture information in a variety of different forms, some lacking key information fields, resulting in a lack of standardization among advisories. Current routing of related advisory information both internally and externally is a manual process and lists of contacts must be maintained. Furthermore, to generate reports, material defect information must be collected, organized and re-keyed into spreadsheets. Reports are manually generated to identify and prioritize improvement opportunities and provide ongoing tracking of raw material quality issues.

As such, a need currently exists for an automated advisory management system that allows for real-time data relay and communication between suppliers and manufacturers concerning defects and other complaints regarding raw materials, packaging supplies and/or other goods and services provided from a supplier to a manufacturer.

### SUMMARY

Objects and advantages of the invention will be set forth in part in the following description, or may be obvious from the description, or may be learned through practice of the invention.

In general, the present invention is directed to a system and method for managing raw material defect complaints with suppliers who provide raw materials or other goods to a product manufacturer. Features associated with the presently disclosed technology provide for a real-time system developed to capture raw material problems, notify suppliers and interested parties, and receive responses in a corrective and preventative action format.

Although the present invention is described herein with respect to a relationship between suppliers and manufacturers and the provision of raw materials, the subject management application could be extended to manage other specific issues, for example, shipping issues such as delays, damage caused by improperly loaded trucks, railcars, seavans, etc. Another example of an alternative extension of the present technology would be to track any warehouse damages, within manufacturing facilities or at distribution centers utilized by a product manufacturer.

A first aspect in accordance with some embodiments of the present invention corresponds to a manufacturer entering an advisory into a computer-based advisory management system. An advisory corresponds to a particular good and may include such information as an identification variable corresponding to the particular good and a defect reason associated with the good. Optional additional information may include a supplier name and contact information, good type, size, weight and batch number. A picture may be linked to the entered advisory to provide additional illustration of the provided defect reasons. A product manufacturer enters an advisory by a data entry system that is linked to a network connecting the supplier and manufacturer. The manufacturer's data entry system may be linked to a web page that provides a graphical interface to assist the manufacturer in entering the advisory. For example, the web page may provide specific data fields that a user must populate for proper creation of an advisory. Data fields for the defect reason and other information may include drop down lists from which the user may select from a plurality of predetermined possibilities, thus helping to standardize certain advisory terminology.

Once an advisory is entered in the computer-based advisory management system, the advisory may be stored in an advisory database and may be automatically reviewed by the system or manually reviewed by an advisory coordinator or system administrator. Upon approval, a notification is sent to the supplier associated with the advisory indicating that an advisory has been entered. Notifications may be sent, for example, via e-mail, facsimile, postal mail, telephone, etc. The advisory may be sent directly to the supplier or a request may be sent for the supplier to log into a secure network portal via a provided URL link to access a new advisory via the advisory management system. Individuals affiliated with the product manufacturer may also sign up via an internal subscription tool for notifications based on selected criteria such as a given supplier or manufacturer facility.

In some instances, an advisory is for informational purposes only and no further actions are required on the part of the supplier before an advisory can be indicated as closed. In other instances, the advisory requires a response indicative of corrective action to be taken on the part of the supplier to rectify the defect reason outlined in the advisory. If a response and/or associated corrective action is required, a response date may be included in the advisory entered by the manufacturer. The supplier must then send such a response by the response date or the supplier management system may send reminder notifications to the supplier. An advisory coordinator or other designated individual on behalf of the manufacturer then reviews the response and any proposed corrective actions submitted by the supplier and has the ability to either accept or reject the proposed response. Once a response is accepted, the advisory may be closed.

An additional feature of the subject supplier advisory management system and method may include a report generation feature whereby selected information can be collected from the advisory database and developed into either a preformatted or an ad-hoc style report. Reports can be customized by various criteria such as time period, supplier, or facility and enable users to track certain advisory issues. Advisory data collected for a report can be exported to a supplemental software program to facilitate customized presentation and data analysis.

Other supplier advisory management system features include a search tool that allows a user to search the advisory database and locate advisories based on specific criteria, an audit tool that enables a user to track information about data that is changed in the system as well as the user and date/time associated with such changes, and an online communication messenger, or chat room, that enables real-time communication between a supplier and manufacturer.

Other features and aspects of the present invention are discussed in greater detail below.

### DRAWINGS

The foregoing and other features, aspects and advantages of the present invention will become better understood with regard to the following description, appended claims and accompanying drawings where:

FIG. 1 provides a block diagram representation of an exemplary advisory management process in accordance with one embodiment of the present invention;

FIG. 2 provides a schematic representation of the interaction among exemplary hardware components of a supplier advisory management system and method in accordance with one embodiment of the present invention; and

FIG. 3 provides a block diagram illustration of a computer-based platform including exemplary system features in accordance with one embodiment of a supplier advisory management system of the present invention.

### DETAILED DESCRIPTION OF THE PREFERRED EMBODIMENTS

The invention will now be described in detail with reference to particular embodiments thereof. The embodiments are provided by way of explanation of the invention, and are not meant as a limitation of the invention. It will be apparent to those skilled in the art that various modifications and variations can be made in the present invention without departing from the scope and spirit of the invention. For example, features described or illustrated as part of one embodiment may be used with another embodiment to yield a still further embodiment. Thus, it is intended that the present invention include these and other modifications and variations as come within the scope and spirit of the invention, including the appended claims and their equivalents.

As used herein, a “product” is any article, good, or composition that can be manufactured and sold. The manufacturer of the product is the “product manufacturer.” In one embodiment, products can include any of the following or combinations thereof: nonwoven webs or articles comprising nonwoven webs, consumer products, disposable products, personal care articles (e.g., incontinence products, tampons, sanitary napkins, diapers, disposable training pants, bandages, and the like), absorbent articles (e.g., diapers, sanitary napkins, tissue products, paper towels, tampons, and the like), disposable medical goods (e.g., sterile wrap, hospital gowns, disposable gloves, catheters, wound dressings, and the like), injection molded articles, automotive articles, durable goods, furniture, construction materials (e.g., dry wall, prefabricated beams, roofing materials, concrete mix, and the like), electronic components (e.g., computers, video recorders, stereo equipment, etc.), textiles, clothing, food, petrochemicals or other chemicals, and the like.

As used herein, a “raw material” is any material or combination of materials that can be used as a component in the manufacture and/or packaging of a product. A raw material for one process may be a product in another process. For example, rubber may be a raw material in the manufacture of radial tires, but radial tires may be considered a raw material in the manufacture of an automobile. Raw materials are typically provided to a manufacturer by internal or external suppliers. In one embodiment, raw materials can be selected from those used in the manufacturer of absorbent articles. Such raw materials can include polymer films, nonwoven webs, woven webs, fibrous webs such as paper or airlaid webs, adhesives, fluff pulp, cellulosic fibers, elastic materials, superabsorbent particles, hook and loop materials, and the like. In another embodiment, raw materials can include those required for the manufacture of cellulosic webs such as tissue, paper towels, moist bath tissue, and wet wipes, including raw materials such as wood pulp, wet strength resins, creping adhesives, emollients, debonders, starch or starch derivatives, silicone compounds, and the like. Raw materials for food products can include specific fruits, vegetables, grains, meats, or extracts thereof, flavorings, spices, starches or other additives, preservatives, colorings, and the like. In further embodiments, raw materials from packaging suppliers include various packaging items such as but not limited to boxes, plastic encasings, labels, packaging inserts, etc.

When raw materials are provided by a supplier to a manufacturer, a possibility exists that the raw materials will not meet certain predetermined specifications and that some raw material defect will exist. Thus, a need exists for a supplier advisory management system in accordance with the present invention to manage raw material defect complaints with suppliers. Such a system and corresponding method enables the use of standardized terminology to describe raw material defects in advisories that are provided to suppliers, track supplier responses in a corrective and preventative action format, and generate various reports for different manufacturer and supplier representatives. In one embodiment, such a supplier advisory management system is an automated real-time computer-based system provided via a web interface. Additional details of a supplier advisory management system as well as related features and corresponding methodology will not be presented.

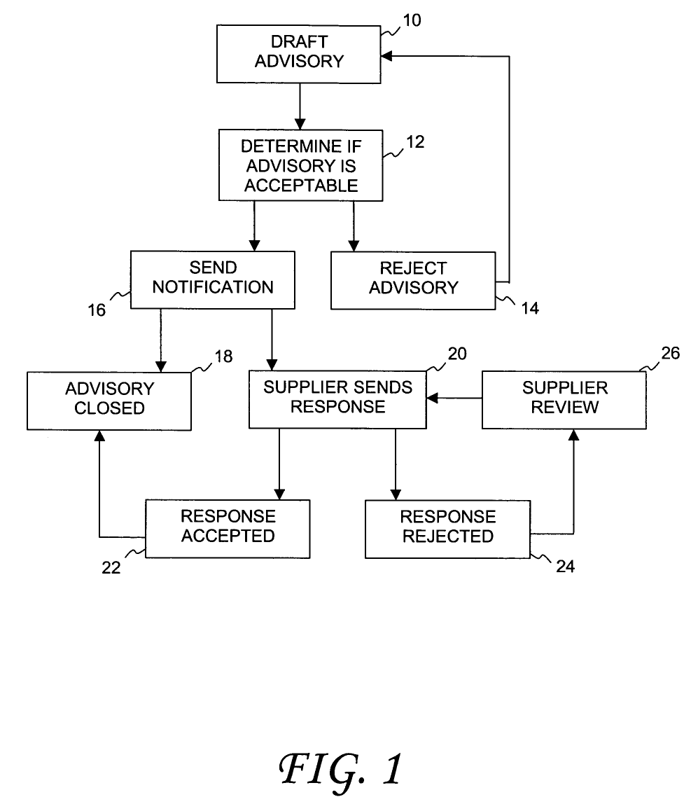

Referring now to FIG. 1, exemplary steps in accordance with one embodiment of an advisory management system and method of the present invention are now presented. A first step 10 in such a method is to enter a draft advisory into the automated supplier advisory management system. Step 10 may be effected by a data entry system available to selected individuals affiliated with a product manufacturer. Advisories include a number of data fields that are entered into the system through a number of available means, including but not limited to, standardized drop down lists, fill in the blank format, and the like. One exemplary data field includes an identification variable such as an inter-mill stock code or item number that is specific to the manufacturer facility (e.g. mill, factory, plant, etc.) that is entering the advisory. After an identification variable is selected, additional data fields are displayed or made available for data population. Additional data fields are intended to further describe the raw material(s) for which an advisory is being submitted. Additional data fields may include, but are not limited to, such information as supplier or vendor name and contact information, raw material type, size, weight, lot/batch number, etc. For each stock code or item number family and supplier combination, additional information fields can be requested. For example, one, two, three or more additional data fields can be requested for specific combinations of raw materials and suppliers. Additional data fields may be requested on behalf of the manufacturer entering the advisory or on behalf of a supplier in order to adequately capture a sufficient amount of information desired for describing a defect complaint and related advisory information.

Referring still to step 10 of FIG. 1, the advisory page accessed by a manufacturer may be adapted with graphics links or imported visual images representative of a specific raw material based on the entered stock code or item number. For example, once such an identification variable is entered on an advisory page that is part of the subject supplier advisory management system, an application database in communication with the supplier advisory management system may be searched for the specific stock code or item number to find a corresponding picture of the supplier's raw material or product or a picture of a label that would be affixed to such a raw material or product. A linked product picture could be used to help the manufacturer confirm that the correct identifying variable information was entered into the system. Also, a linked label picture could provide information for helping the manufacturer locate additionally required information on the item such as a lot/batch number for the raw material, etc.

Additional data that is entered on an advisory form/page in step 10 corresponds to a defect reason. Since the defect reason is a significant data field, it may be beneficial to accommodate standardization of possible defect reasons when possible. For example, a drop down list may be available whereby a defect reason can be selected by a user from one of a plurality of possible entries. Such a standardized drop down list may include defect reasons that are sometimes known to exist for a particular material family based on one or more identifying data variable. Although it may be desired in some embodiments of the present invention to require standardized entries for possible defect reasons, it should be appreciated that some embodiments may provide for selection of a “new” or “other” defect reason. Default reasons may be specified by manually entering a description in a designated fill in the blank form or similar data field. Thus, defect reasons may be standardized, customized or some combination thereof.

Still further information that may be provided in step 10 of entering a draft advisory or that may be provided at a subsequent point but before an advisory is sent to or made available for viewing by a supplier is an indication of whether the advisory is for informational purposes only or if corrective action is required. If the advisory requires a response from the supplier, corrective action by the supplier, or other action, then additional information may also be provided to indicate, for example, a response due date. After all data has been entered, the supplier advisory management system program could require that the user verify that the data has been entered properly.

Referring still to FIG. 1, after a draft advisory is entered in step 10, a review of the advisory may be performed in step 12 to determine if the advisory is acceptable. In one embodiment, the advisory review in step 12 may be performed automatically by the computer-based advisory management system to make sure that certain required fields are populated with valid information before the advisory is sent to a supplier. In another embodiment, one or more data fields in the advisory are reviewed manually by an advisory coordinator or system administrator to ensure that the advisory meets certain predefined criteria and receives approval before being sent to a supplier. If any facet of the advisory is found to be unacceptable by automated and/or manual review in step 12, then the advisory may be rejected in exemplary step 14 at which point the subject process returns to step 10 where the draft advisory may be modified or re-entered. If the advisory is found to be acceptable in step 12, then an advisory notification is sent in step 16. In one embodiment, the supplier advisory management system sends a notification to a supplier notifying them that an advisory has been entered. Notification contact may be made in one or more of several possible ways, including but not limited to electronic mail (e-mail), postal mail, telephone and facsimile. In one particular embodiment, notification is sent by e-mail to a supplier advising them to log into the supplier advisory management system via a secure network portal to review the advisory and respond if required. Suppliers may be provided with a URL link to the supplier side of the system which allows access through a firewall portal to a secure web site where the supplier can directly respond via a supplier data entry system to the site issuing the advisory. In further accordance with this particular exemplary embodiment, once a supplier logs into the supplier advisory management system, the supplier is able to view the entire advisory. When an advisory or corresponding advisory notification is sent to a supplier, a communication, for example via e-mail, may also be sent to selected manufacturer contacts that have signed up via a subscription service to receive notifications.

Referring still to FIG. 1, if an advisory is merely provided to a supplier for informational purposes, then after the notification is sent in step 16, the advisory is then considered closed as indicated in a step represented by box 18. For other advisories, a supplier may send a response to the manufacturer in step 20. A supplier response provided in step 20 may provide detailed indication of the corrective actions that will be undertaken by the supplier to rectify the defect problem outlined in the advisory. An advisory coordinator or other entity selected on behalf of the manufacturer may choose to accept the response in step 22 submitted by the supplier in step 20 or may reject the response such as indicated in step 24. If the manufacturer rejects the supplier response in step 24, then the supplier must review the response in exemplary step 26 and resubmit a response in step 20. This should proceed until the supplier response is accepted by the manufacturer in step 22 at which point the advisory may be closed as indicated in step 18. An advisory coordinator or other manufacturer representative may have the option in one embodiment to extend the corrective action response due date to allow the supplier to complete an investigation before responding with a corrective action. If no response is received from the supplier by the requested date, the supplier advisory management system can generate a reminder communication (e.g., a reminder e-mail). In one exemplary embodiment of the present invention, step 20 taken by the supplier as well as steps 22 and/or 24 implemented by an advisory coordinator or other designated manufacturer entity may require the submission of an electronic signature to verify the relayed information. Such an electronic signature or other obtained information such as a user ID can all be stored on a server for subsequent review as needed.

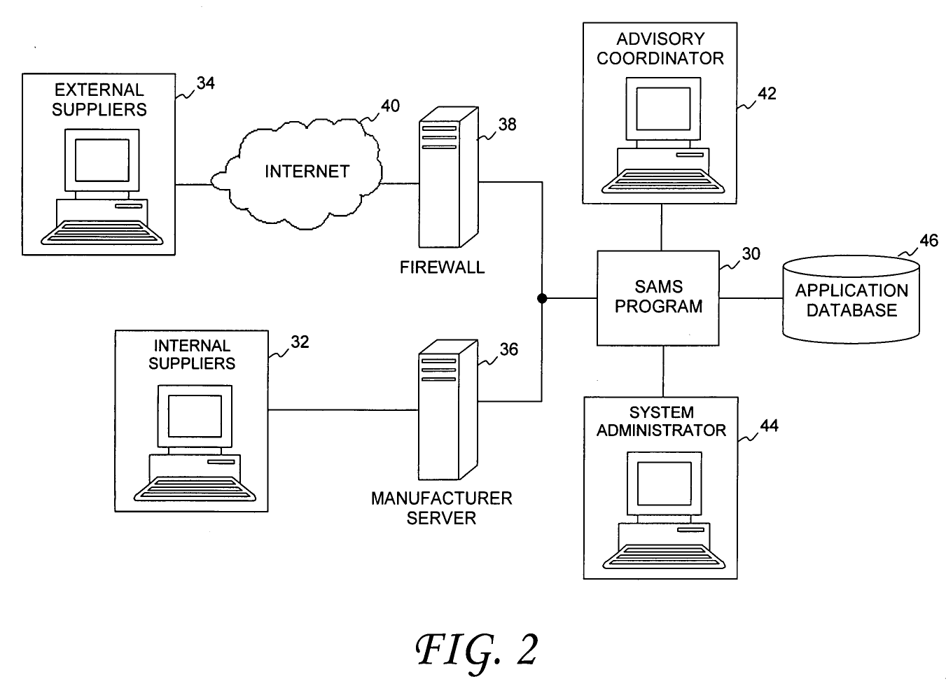

Referring now to other aspects of the present invention, FIG. 2 illustrates an exemplary relationship between several hardware components used in one embodiment of a supplier advisory management system of the present invention. In accordance with the exemplary embodiment illustrated in FIG. 2, multiple different supplier and manufacturer entities can access the supplier advisory management system (SAMS) application or program 30. Each entity has access to SAMS application 30 via a computer provided with some sort of data entry system (e.g., keyboard, touch-screen monitor, mouse, scanner, etc.)

Supplier entities include both internal suppliers 32 and external suppliers 34. Internal suppliers 32 can include entities within the same organization as the product manufacturer or affiliated with the product manufacturer such that they have access to a corporate Intranet or other internal network of computers such as a LAN. Internal suppliers 32 can include makers of components needed in the manufacture of the product (not shown). For example, in the production of diapers or other absorbent articles, the product manufacturer may own or control facilities that make components such as fluff pulp, films for use in an outer cover, adhesive compositions, tissue layers, nonwoven webs serving as an intake material or liner against the body, elastic components in cuffs and waist bands, hook and loop materials for fastening the article, odor control components, superabsorbent particles or fibers, and the like. Any of these components of the product may be made internally by teams with access to a corporate Intranet supported by manufacturer server 36.

External suppliers 34 can be any firm that makes a raw material used in the manufacture of a product by the product manufacturer, wherein the firm does not have access to private manufacturer servers 36 of the product manufacturer. The private manufacturer servers 36 are generally protected from external sources by a firewall 38 or other secure hardware component under control of the product manufacturer. External suppliers 34 can provide data such as an advisory response to the supplier advisory management system 30 by data entry devices integrated with computers connected to the Internet 40 by accessing a secure Web site of the product manufacturer accessible via Internet 40 and protected by a firewall 38. Access can be via a password-protected account. A user from an external supplier 34 enters a URL to access a secure Web site. The URL request goes through the firewall 38 to a router (not shown) where a domain name server determines the IP address to be used for the requested URL. A signal for creating a Web page display is then routed back to the external supplier's computer. Internal suppliers 32 can access the supplier advisory management system 30 via a corporate Intranet hosted on manufacturer server 36 in much the same way the external supplier 34 does via a connection over Internet 40.

Individuals affiliated with the product manufacturer that may access the supplier advisory management system application 30 include one or more advisory coordinators 42 and one or more system administrators 44. In some embodiments, an advisory coordinator 42 may be responsible for overseeing the submission and follow-up of advisories entered into the system by employees of the product manufacturer. In other embodiments, one or more advisory coordinators 42 are the ones who enter advisories into the system and who also proceed with such follow-up steps as reviewing and either accepting or rejecting a supplier response. An advisory coordinator may also access the SAMS application to generate advisory reports, conduct audits, and perform other desired analysis. A system administrator 44 typically has at least the same access abilities within the SAM program 30 as an advisory coordinator 42, but also has extended abilities to conduct administrative actions. Administrative actions may include modifying standardized drop down lists for the advisory data fields, such as the defect reason, updating supplier information, modifying the appearance or function of a Web-interface or other interface provided to advisory coordinators, internal and/or external suppliers, modifying system specifications for SAMS program 30, deleting or modifying information stored in an advisory database 46, providing audit information, modifying notification subscription or other accounts, and the like.

Referring still to FIG. 2, an advisory database 46, which may be provided on a dedicated server or on an application server running SAMS program 30, stores data provided when new advisories are entered into the system. The advisories stored in database 46 are searchable based on different selected data fields provided in the advisories. Any modifications made to existing advisories are also stored in advisory database 46, including time stamps and identification information for the user who made such modifications such that advisory changes can be subsequently tracked by audits.

Additional details regarding exemplary hardware components with which the subject supplier advisory management system and method may be incorporated are disclosed in U.S. Patent Application 2003/0069795, concerning a supplier data management system, which is incorporated herein by reference for all purposes.

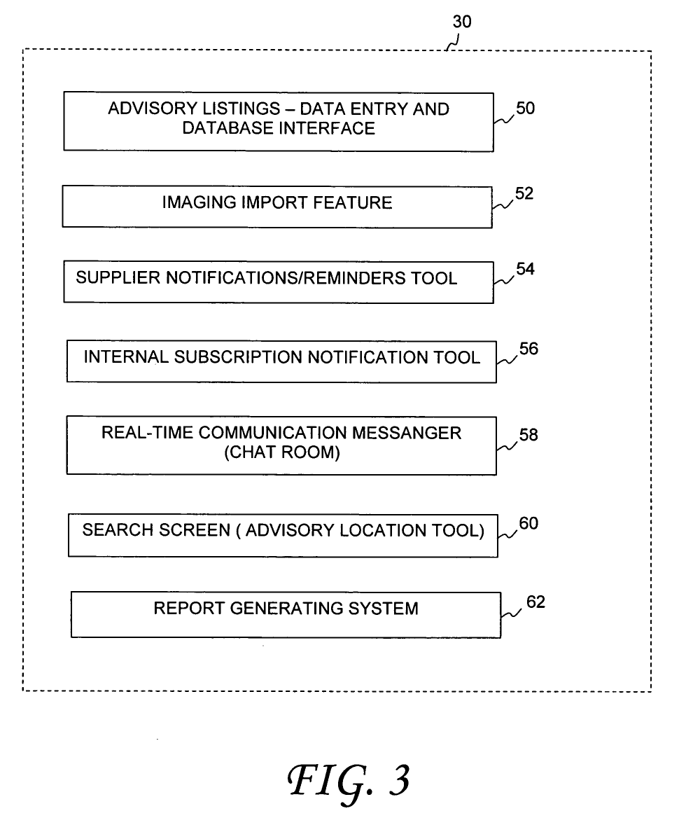

Referring now to FIG. 3, exemplary system features of the subject supplier advisory management system (SAMS) program and corresponding computer-based platform will now be discussed in further detail. A first system feature 50 available in exemplary embodiments of the SAMS application corresponds to an option for entering new advisory listings. Advisory listing feature 50 is utilized in step 10 of FIG. 1 when a user on behalf of the product manufacturer enters an advisory into the supplier advisory management system. A data entry interface for the advisory listing includes, as previously described with respect to FIG. 1, a combination of drop down lists, fill in the blanks and other entries for various data fields. The type and number of data fields available for each advisory may be predetermined based on the stock code or item number family and supplier combination. Advisories entered via a user's data entry system are then stored in an advisory database 46 as seen in FIG. 2, where the advisory can subsequently be accessed for review, search, audit, or other reason.

Another feature of SAMS application 30 is an imaging import feature 52. Via imaging import feature 52, a user can import/upload images of a defective material and attach such image to a related advisory. Images can be scanned in from a picture taken of the defective material when a user's data entry system includes a scanner or the like. Alternatively, a digital camera can be linked to the user's computer system and a digital image uploaded from this type of peripheral device. Linked images to a supplier's raw material that visually illuminate defect reasons outlined in an advisory notice can provide valuable information for a supplier, often facilitating the supplier's ability to provide an acceptable response and corrective action to a submitted advisory.

Referring still to FIG. 3, another aspect of the subject supplier advisory management system 30 includes a supplier notifications/reminders tool 54. Notifications tool 54 corresponds to software in the system that triggers a signal generator for sending notifications to internal or external suppliers upon an approved advisory being entered into the supplier advisory management system via feature 50. In one embodiment, generated notifications can correspond to an e-mail correspondence including an entire advisory, a link to an advisory, or a notification for the supplier to log into a designated web portal to view a new advisory. Notifications tool 54 can also be configured to send automatic reminders to a supplier, particularly when no response is received from the supplier by the date requested in the advisory.

Notifications in accordance with the present subject matter are not only provided to suppliers. In accordance with an internal notification subscription tool 56, personnel affiliated with the product manufacturer can sign up for communication notifications (e.g., e-mails) based on select advisory criteria. Advisory coordinators, system administrators and additional approved employees of the product manufacturer that require notifications of advisories will be able to tailor the notifications they receive via subscription notification system feature 56. For example, individuals can sign up via subscription notification tool 56 to receive communication notifications based on factors including, but not limited to, specific material(s), mill(s) or supplier(s), thus allowing an individual to limit the number of advisory notifications they receive only to those advisories that they help support or have other particular interest in.

Continuing with a discussion of exemplary features of supplier advisory management system 30 as depicted in FIG. 3, a real-time online communication messenger feature 58 may be provided in some embodiments. In one embodiment of communication feature 58, a communication “chat room” or instant messaging interface enables a supplier and advisory coordinator or other designated individual on behalf of the manufacturer to communicate information about a given advisory. All communications can be logged and available for review. In another embodiment, e-mails that are sent back and forth between a manufacturer and supplier can be logged with the rest of the advisory information stored in the application database 46, and can be reviewed as desired by either entity. Feature 58 enables communication to resolve issues regarding advisories and corrective action as discussed among product manufacturer facilities, business support teams and their raw material or packaging suppliers via the Internet.

In one embodiment, supplier advisory management system 30 further includes a search feature 60 that provides a user interface (e.g., search screen) for an advisory coordinator or other employee on behalf of the product manufacturer to search and locate specific advisories stored in the advisory database 46 (represented in FIG. 2). Searches performed via search tool 60 may be filtered by different criteria including, but not limited to, the mill, supplier, status, material type, etc. The searching algorithm may be performed in one of many ways known in the art, including but not limited to free-form key word searching, fix-termed key word searching and the like.

Referring still to FIG. 3, a report generating system 62 may also be included in the subject supplier advisory management system 30. Report system 62 can generate pre-formatted or ad-hoc reports that can be customized by various criteria such as time period, supplier, plant/mill facility, etc. Reports can be generated for individual mill sites, cross-sectors, and mills that use the same type(s) of raw materials. Pre-formatted or ad-hoc reports can be generated via feature 62 to track, for example, raw material issues over time, by supplier and/or by number of advisories. Pre-formatted reports may contain both line item type reports of advisories as well as trending of advisories. Reports can be generated automatically or the information can exported to a supplemental program such as Microsoft® Excel to allow data to be used in customized formats or modified to suit specific purposes for a report. Reports generated via system feature 62 can serve as a key source of information in determining potential improvement opportunities for the supplier, mill and staff resources to improve product and service quality.

The supplier data management system 30 also provides for a thorough audit trail. All entries and actions in the supplier advisory management system 30 can be traced, dated, archived, and audited to ensure compliance with applicable industry standards and requirements. Specific advisories or portions thereof can be deleted if any portion of the data was entered in error, although in one embodiment information that has been archived is not editable. In another embodiment, if errors are to be changed, the archived records should provide an audit trail including information about the original entry and the requested change. Raw material suppliers are able to update the entered data, wherein archived documentation is provided by an advisory coordinator or system administrator and states any corrections and the reasons for the corrections. Electronic signatures and time stamping may be used to authenticate dates and accountability. Audit trails for an advisory can be configured to track the user that modified or deleted an advisory, the date/time the modification was made, the old field value(s) and the new field value(s) for each field modified.

The supplier advisory management system 30 can be connected to or communicate with a number of other systems to increase the efficiency of a business. First, the supplier advisory management system 30 can be part of supplier data management system, such as the kind described in U.S. Patent Application No. 2003/0069795. Second, the supplier data management system 30 can be part of an integrated manufacturing system, such as the kind described in U.S. Pat. No. 5,311,438, “Integrated Manufacturing System,” issued May 10, 1994. Any known software can serve as the basis for the integrated manufacturing system, including products from WonderWare, Inc., Rockwell, Microsoft, and other vendors.

Third, the supplier advisory management system 30 can be incorporated into or linked with known software such as electronic data interchange (EDI) systems and SAP software. The supplier advisory management system 30 can also be integrated with quality control systems such as a distributed control system (DCS) and with computer-integrated manufacturing in general. The supplier advisory management system 30 can be integrated with SAP/R3 systems. For example, encapsulation of custom software, such as any supplier advisory management system component, can occur within SAP using SAP interface programs, called business application programming interfaces (BAPIs), which use Microsoft COM/DCOM connectors, allowing a Microsoft-based client to communicate with SAP R/3. Such connectors can be built using Microsoft ActiveX and COM/DCOM strategies. Known certificate of analysis generation tools can also be adapted, including the Proficy Certificate of Analysis Wizard, which is an ActiveX control.

Fourth, the supplier advisory management system 30 can be integrated with commercial quality control software, such as TRAQ-1 Quality Data Management System of the Gibson-Graves Company, Inc. This VAX-compatible software assists in the management of quality assurance information. This system is said to offer SPC (statistical process control) capability, as well as a range of data entry, analysis, graphics and reporting features. This system provides control for raw materials, process, and finished products. There are specific modules for tracking and reporting of defective materials and returned goods, certificates of analysis, and vendor analysis. This system also provides full database query and reporting capabilities. Graphical output includes control charts, histograms, Pareto charts, cusum charts, x-y correlations, etc. DBQ software can also be coupled with the supplier advisory management system 30.

Fifth, the supplier advisory management system 30 can be integrated with a system such as the Taratec e-Compliance.™. Solution (TeC) system from Taratec of Bridgewater, N.J. This system enables data and file management to be controlled in a secure repository that supports the requirements of 21 CFR Part 11. This system allows security for all information to be maintained through Access Control Lists (ACLs), which provide the flexibility to grant access as required while protecting files against accidental modification or unauthorized access. The TeC system also allows users with appropriate permission to update individual files while maintaining copies of the original record and all subsequent versions. Secure audit trails capture information including date of modification, who modified the file, and why the file was changed. The TeC system is integratable into most existing computer systems and is non-invasive to data sources or applications. Systems supported include laboratory instrument data collection applications, data entry applications, and electronic batch records systems as well as Excel spreadsheets and Word files. Accessible through a Web browser, the TeC system stores all files, from raw data to Certificates of Analysis, in a secure, central location with a full audit trail. Building on the Oracle8i platform (Oracle Corporation), the TeC system provides the security and reliability of a Relational Database Management System (RDBMS) along with ease of use associated with standard file systems.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention.

What is claimed is:

1. A method of managing defect complaint advisories for goods provided from a supplier to a manufacturer, said method comprising the following steps:
the manufacturer entering an advisory into a computer-based advisory management system, wherein said advisory corresponds to a particular good and includes information including an identification variable corresponding to the particular good and a defect reason associated with the good;
transmitting to the supplier a notification that an advisory has been entered into the computer-based advisory management system; and
the manufacturer closing the advisory such that the computer-based advisory management system indicates that no further follow-up actions are required on the part of the supplier.

2. The method of claim 1, wherein said step of the manufacturer entering an advisory further comprises selecting a defect reason from a display of at least two predefined material defect reasons.

3. The method of claim 1, wherein said step of the manufacturer entering an advisory further comprises linking a visual image to the advisory to illustrate aspects of the defect reason associated with the particular good.

4. The method of claim 1, wherein the entered advisory further includes information corresponding to one or more of the supplier name and contact information, good type, size, weight and batch number.

5. The method of claim 1, further comprising a step of reviewing the entered advisory before said step of transmitting a notification to the supplier.

6. The method of claim 1, wherein the entered advisory further includes information identifying a date by which the supplier needs to respond to the advisory entered in the computer-based advisory management system and wherein the method further includes the following steps before said step of closing the advisory:
the supplier sending a response to the advisory entered in the computer-based advisory system, wherein the response provides an indication of the corrective actions that will be undertaken to rectify the defect reason provided in the advisory; and
the manufacturer accepting the response sent by the supplier.

7. The method of claim 6, further comprising the following steps before said step of the manufacturer accepting the response:
the manufacturer rejecting the response said by the supplier; and
the supplier revising the response and resubmitting it to the manufacturer.

8. The method of claim 6, further comprising the step of:
after the date entered in the advisory management system by which the supplier needs to respond has lapsed, sending a reminder notification to the supplier regarding the need to respond to the advisory.

9. The method of claim 1, wherein the notification sent to the supplier is sent via one of postal mail, electronic mail, telephone or facsimile.

10. The method of claim 1, further comprising a step of the supplier logging into the computer-based advisory management system via a secure network portal to view the advisory identified in the notification transmitted to the supplier.

11. An advisory management system for managing defect complaints for materials provided from a supplier to a manufacturer, the system comprising:
a network adapted to permit data transfer between a manufacturer and a supplier, wherein the manufacturer produces a product, and wherein the supplier supplies one or more raw materials;
a first data entry system connected to the network, wherein the first data entry system is adapted to permit the manufacturer to enter advisory information for access by the supplier via said network;
a second data entry system connected to the network, wherein the second data entry system is adapted to permit the supplier to enter and submit responses to selected advisories entered by the manufacturer; and
an advisory database coupled to said network for storing selected advisory information entered by the manufacturer via said first data entry system.

12. The advisory management system of claim 11, wherein said first data entry system is further adapted to permit the manufacturer to generate reports from selected advisory information stored in said advisory database.

13. The advisory management system of claim 11, wherein said first and second data entry systems are linked to a Web page that provides a graphical interface for the manufacturer and supplier to respectively enter selected information.

14. The advisory management system of claim 11, wherein said first data entry system comprises means for selecting a material defect reason from a display of at least two predefined material defect reasons.

15. The advisory management system of claim 11, wherein said first data entry system comprises a scanner.

16. The advisory management system of claim 11, wherein said first data entry system is further adapted to permit the manufacturer to search the advisory database and locate advisories based on selected search criteria.

17. The advisory management system of claim 11, wherein the network comprises one of the Internet and an intranet.

18. The advisory management system of claim 11, further comprising a connection between the system and one or more of an integrated manufacturing system, an electronic data interchange system, a quality control software system, an access security system, and a vendor inventory management system.

19. The advisory management system of claim 11, further comprising a communication channel established across said network between said first and second respective data entry systems to enable real-time communication of advisory information between the supplier and the manufacturer.

20. The advisory management system of claim 11, further comprising time stamping means for documenting actions taken with respect to the system.

21. A computer based application for managing defect complaints for products provided from a supplier to a manufacturer, said application comprising:
a data entry interface for the manufacturer to enter new advisories, wherein said data entry interface provides data fields corresponding to information including one or more product identification variables and a defect reason for each product in a new advisory, whereby advisory data entered via said data entry interface is stored in an advisory database;
a external signal generator configured to send a notification to the supplier when a new advisory is entered into the computer based application and stored in the advisory database; and
a report generator configured to collect selected information from the advisory database and present it to a user in one of a predetermined or a customized format.

22. The computer-based application of claim 21, wherein said data entry interface includes at least one drop down list for selecting a material defect reason from a display of at least two predefined material defect reasons.

23. The computer-based application of claim 21, wherein said external signal generator sends the notification via electronic mail.

24. The computer-based application of claim 21, wherein said signal generator is further configured to send reminder notifications to a supplier after a predetermined amount of time has lapsed since sending previous notification.

25. The computer-based application of claim 21, wherein said report generator is configured to export upon user request selected information collected from the advisory database to a supplemental computer-based program.

26. The computer-based application of claim 21, further comprising an image link for importing one or more graphical images of a product identified in a given advisory such that the supplier may be provided with a visual illumination of the defect reason provided in the advisory.

27. The computer-based application of claim 21, further comprising an internal signal generator configured to send a notification to selected individuals affiliated with the product manufacturer upon a new advisory being entered into the computer based application and stored in the advisory database.

28. The computer-based application of claim 21, further comprising an online communication messenger for the supplier and manufacturer to send real-time communications between one another to discuss information regarding corrective actions for a given advisory.

29. The computer-based application of claim 21, further comprising a search interface for the manufacturer to locate select advisories from the advisory database.
